(19) United States
(12) Patent Application Publication
(10) Pub. No.: US 2024/0042919 A1
(43) Pub. Date: Feb. 8, 2024

(54) RATCHET STRAP REEL

(71) Applicant: Bill Bolinger, Creston, IA (US)

(72) Inventor: Bill Bolinger, Creston, IA (US)

(21) Appl. No.: 18/328,340

(22) Filed: Jun. 2, 2023

Related U.S. Application Data
(60) Provisional application No. 63/348,564, filed on Jun. 3, 2022.

(51) Int. Cl. B60P 7/08; B65H 54/58

(52) U.S. Cl. CPC B60P 7/0846; B65H 54/585; B60P 7/083

(57) ABSTRACT

A reel device for a ratchet strap system is described. The reel device includes a base that removably receives a first strap of the ratchet strap system. The reel device further includes a receiver that removably receives a second strap of the ratchet strap system. The reel device also includes a reel mechanism operatively connected to the receiver. When the reel mechanism rotates a first angular distance, the receiver rotates a second angular distance proportional to the first angular distance in a same direction as the first angular distance. When the receiver is rotating while receiving the second strap of the ratchet strap system, the second strap wraps around the receiver.

### PRIORITY INFORMATION

This application claims the benefit of U.S. Provisional Application No. 63/348,564, filed Jun. 3, 2023, the entire contents of which are incorporated herein by reference.

### TECHNICAL FIELD

The disclosure relates to securement hardware. More specifically, the disclosure relates to organization and management of ratchet straps.

### BACKGROUND

Ratchet straps are versatile mechanisms that allow for the securement of cargo to a transportation surface such that the cargo does not move and is not damaged during transportation. In order to be versatile and handle a variety of different sized cargo, ratchet straps tend to be much longer than other types of straps, with the ratchet mechanism receiving one part of the strap and tightening the strap around the cargo. However, this can create another danger. When cargo is smaller, or the ratchet straps are simply lying over a transportation surface without cargo, the unruly length of the ratchet straps can cause the loose ends fed through the ratchet mechanism wave around while the vehicle is in motion. This can damage other vehicles on the road or the vehicle that is attached to the ratchet strap itself.

### SUMMARY

In general, the disclosure is directed to a reel device that is attachable, removably or otherwise, to existing ratchet strap systems. The reel device includes a receiver that can receive the portion of the ratchet strap system that is fed through the ratchet mechanism. When the ratchet mechanism tightens the ratchet strap around the intended surface, there may be a portion of the ratchet strap that hangs loose from ratchet mechanism. The reel device attaches to the a strap in the ratchet strap system that also is attached on one end to the ratchet mechanism itself. The loose portion of the second strap that is fed through the ratchet mechanism is received by a receiver in the reel device. Once the receiver has received the second strap, a reel mechanism may be activated to rotate the receiver. As the receiver rotates, the second strap wraps around the receiver, securing the loose portion of the second strap to the reel device itself

Rather than allowing the loose portion of the strap to flail around during transportation, potentially damaging objects around the ratchet strap system, the reel device secures the strap in a compact, secure, and safe location. In instances where the reel device is removably attachable to the ratchet strap, the reel device can be universal and attached to any number of existing ratchet straps. In this way, users do not need to purchase entirely new ratchet strap systems, or purchase ratchet strap systems designed to fit specific jobs. Rather, the reel device can attach to existing ratchet strap systems and can compensate for larger ratchet strap systems being used on smaller cargo, or no cargo at all when the ratchet straps are engaged over empty transportation platforms, such as trailers without cargo.

In one example, the disclosure is directed to a ratchet system. The ratchet system includes a first strap. The ratchet system further includes a second strap. The ratchet system also includes a ratchet mechanism attached to a first end of the first strap. The ratchet system further includes a reel device. The reel device includes a base that removably receives the first strap. The reel device further includes a receiver that removably receives a first end of the second strap. The reel device also includes a reel mechanism operatively connected to the receiver. When the reel mechanism rotates a first angular distance, the receiver rotates a second angular distance proportional to the first angular distance in a same direction as the first angular distance. When the receiver is rotating while receiving the second strap of the ratchet strap system, the second strap wraps around the receiver.

In another example, the disclosure is directed to a reel device for a ratchet strap system. The reel device includes a base that removably receives a first strap of the ratchet strap system. The reel device further includes a receiver that removably receives a second strap of the ratchet strap system. The reel device also includes a reel mechanism operatively connected to the receiver. When the reel mechanism rotates a first angular distance, the receiver rotates a second angular distance proportional to the first angular distance in a same direction as the first angular distance. When the receiver is rotating while receiving the second strap of the ratchet strap system, the second strap wraps around the receiver.

In another example, the disclosure is directed to a method for installing a ratchet strap system. The method includes, for a first strap that includes a ratchet mechanism on a first end of the first strap, attaching a first hook on a second end of the first strap to an attachment point on a first surface. The method further includes, for a second strap that includes a strap tip on a first end of the second strap, attaching a second hook on a second end of the second strap to an attachment point on a second surface. The method also includes inserting the strap tip of the second strap into the ratchet mechanism on the first strap. The method further includes activating the ratchet mechanism to receive additional portions of the second strap through the ratchet mechanism. The method also includes attaching a reel device to the first strap, the reel device comprising a base, a receiver, and a reel mechanism. The method further includes inserting the strap tip of the second strap into the receiver of the reel device. The method also includes activating the reel mechanism to rotate the receiver, wherein rotating the receiver causes the second strap to wrap around the receiver.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a perspective view of an example ratchet system with a reel device described in accordance with the techniques and devices of this disclosure.

FIG. 2 is a conceptual diagram illustrating a zoomed side view of an example ratchet system with a reel device described in accordance with the techniques and devices of this disclosure.

FIG. 3 is a conceptual diagram illustrating a zoomed side view of an example ratchet system with a reel device described in accordance with the techniques and devices of this disclosure.

FIG. 4 is a conceptual diagram illustrating a zoomed front view of an example ratchet system with a reel device described in accordance with the techniques and devices of this disclosure.

FIG. 5 is a conceptual diagram illustrating an example reel device with a compound receiver, described in accordance with the techniques and devices of this disclosure.

FIG. 6 is a conceptual diagram illustrating a zoomed front view of an example reel device, described in accordance with the techniques and devices of this disclosure.

FIG. 7 is a conceptual diagram illustrating an example ratchet system with a reel device in use on a truck with a payload, described in accordance with the techniques and devices of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

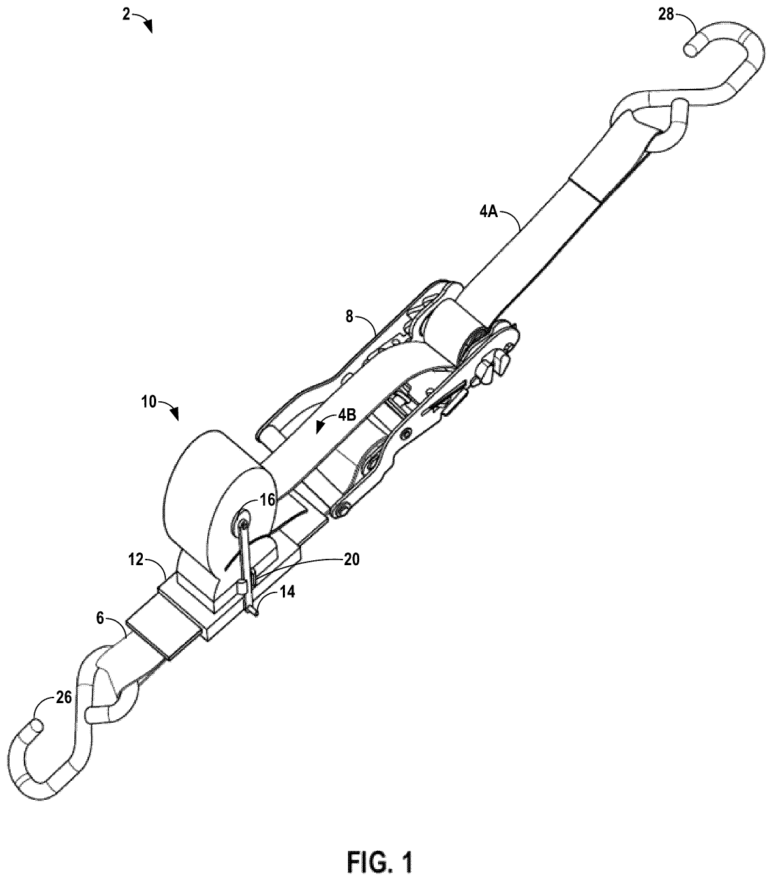

FIG. 1 is a conceptual diagram illustrating a perspective view of an example ratchet strap system 2 with a reel device 10 described in accordance with the techniques and devices of this disclosure. Ratchet strap system 2 includes strap 6. Strap 6 is attached to ratchet mechanism 8 on a first end and hook 26 on a second end. Hook 26 may be attached to a surface to help keep strap 6 installed in place. Strap 6 may be any suitable material, such as polyester, polyester webbing, nylon, or any other type of sturdy and flexible material.

A second strap is made up of a first end 4A and second end 4B. The second strap also includes hook 28, which may be attached to a surface to help keep the strap made up of first end 4A and second end 4B.

Ratchet strap system 2 works by placing a tip of second end 4B into a receiver of ratchet mechanism 8. Once second end 4B is through the receiver of ratchet mechanism 8, a user may activate or pump a handle of ratchet mechanism 8. As the user activates or pumps the handle of ratchet mechanism 8, the receiver of the ratchet mechanism rotates in a single direction, while a locking mechanism restricts the receiver from rotating in the opposite direction. As the receiver rotates from the pumping of the handle, more and more of first end 4A of the second strap goes through the receiver, thereby tightening ratchet strap system 2 around some surface or cargo, securing that surface or carbo in place, such as during transportation.

In many cases, such as examples where straps 4A/4B and 6 are quite long, second end 4B of the second strap can hang loose from ratchet strap system 2. When the surface or the cargo is stationary, this may not affect ratchet strap system 2 or the surroundings. However, when in motion, second end 4B of the second strap can begin flailing around, potentially damaging the surface or cargo ratchet strap system 2 is intending to secure, or the surroundings or other vehicles.

As a solution to a loose second end 4B, reel device 10 can secure second end 4B to restrict second end 4B from potentially damaging cargo or the surroundings of ratchet strap system 2. Reel device 10 includes base 12, a reel mechanism made up of spindle 14 and rotor 16, and, in some instances, spindle lock 20. Reel device 10 is only one example of a potential reel device that may be used in accordance with the description provided herein. For instance, other examples of the reel device may include additional parts or fewer parts than those pictured in FIG. 1. For instance, a reel device created in accordance with the techniques described herein may or may not include a covering over the reeled portion of second end 4B of the second strap, or may include a smaller version of base 12, or may not include spindle lock 20. Additionally, the various components of reel device 10 may be made of any material suitable for the functions of that component within reel device 10, such as metal, plastic, rubber, silicone, cloth, or any combination thereof.

Reel device 10 also includes a receiver (not pictured in FIG. 1). Base 12 of reel device 10 may be removably attached to strap 6. For instance, base 12 may be ‘C’-shaped, with one open side such that base 12 may slide onto strap 6. The interior opening in base 12 may, in some instances, include friction-creating material, such as rubber or silicone, to help base 12 grip onto strap 6 and keep reel device 10 in place. Reel device 10 may also be placed onto strap 6 prior to the user tightening ratchet system 2, enabling base 12 to be secured to ratchet strap system 2 from the pressure generated by a tightened ratchet strap system 2.

A tip or distal portion of second end 4B of the second strap may be fed into the receiver of reel device 10. In some instances, the receiver may include internal components, such as a gripping mechanism, to generate additional force or friction on second end 4B, such as teeth, rubber, silicone, a friction pad, or other materials or structures. Once received, spindle 14 may be rotated around rotor 16. As spindle 14 and rotor 16 rotate, the receiver also rotates. This rotation causes second end 4B to wrap around the receiver, thereby securing second end 4B to reel device 10 and restricting the free motion of second end 4B.

When satisfied with the amount of second end 4B reeled up into reel device 10, if reel device includes a locking, stopper, or restriction mechanism that applies tension to the reel mechanism, such as spindle lock 20, the user may activate spindle lock 20 by placing spindle 14 into spindle lock 20 to keep spindle 14 from rotating in the opposite direction and unraveling. In other examples, the stopper mechanism may be a gear, either internal or external, that applies tension to rotor 16.

In other words, when the reel mechanism rotates a first angular distance, the receiver may also rotate a second angular distance proportional to the first angular distance in a same direction as the first angular distance (e.g., 1:1 angular distance, 1:2 angular distance, etc.). When the receiver is rotating while receiving second end 4B of the second strap of ratchet strap system 2, the second strap wraps around the receiver.

In some instances, the receiver may include a release mechanism. When activated, the release mechanism may cause the receiver to loosen the hold on second end 4B of the second strap by the receiver, such as by loosening the gripping mechanism or reducing the pressure or friction applied to second end 4B of the second strap. For instance, in some instances, spindle 14 may further act as the release mechanism. A user may lift spindle 14 to be in line with rotor 16. When lifted, the receiver of reel device 10 and/or base 12 may loosen that component's grip on the respective strap received by that component. When spindle 14 is dropped back into the position where spindle 14 may spin around rotor 16, the receiver and/or base 12 may tighten down on the respective strap, securing reel device 10 and strap 4B in place. Additionally, in some instances of securing base 12 on strap 6, reel device 10 may include a lock or a cover that can be flipped over the opening of base 12 after putting strap 6 and reel device 10 in place.

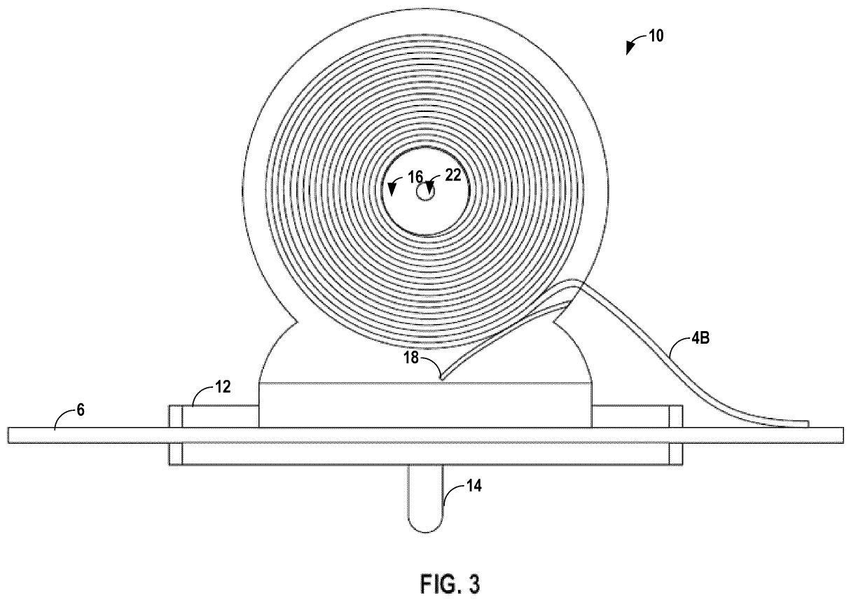

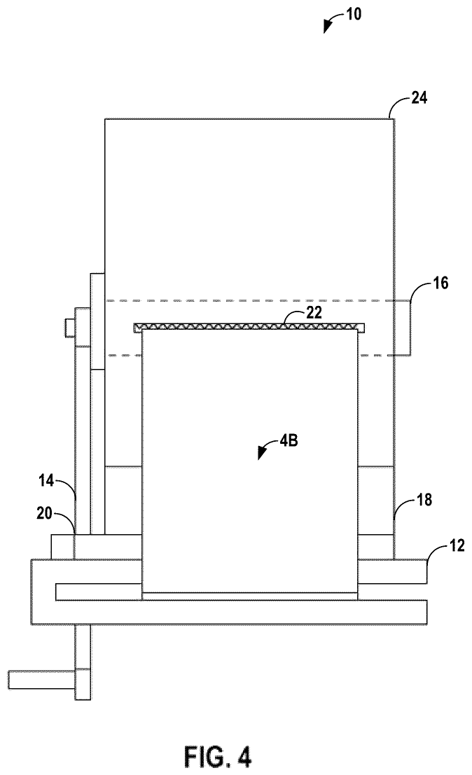

In accordance with the techniques described herein, in installing ratchet strap system 2, for strap 6 that includes ratchet mechanism 8 on a first end of strap 6, the method includes attaching hook 26 on a second end of strap 6 to an attachment point on a first surface. For a second strap made up of first end 4A and second end 4B, that includes a strap tip on second end 4B of the second strap, the method includes attaching hook 28 on first end 4A of the second strap to an attachment point on a second surface. The method further includes inserting the strap tip of second end 4B of the second strap into ratchet mechanism 8 on strap 6. The method also includes activating ratchet mechanism 8 to receive additional portions of the second strap through ratchet mechanism 8. The method further includes attaching reel device 10 to strap 6, reel device 10 including base 12, a receiver (such as receiver 22 of FIGS. 3 and 4), and a reel mechanism, such as the reel mechanism made up of spindle 14 and rotor 16. The method also includes inserting strap tip of second end 4B of the second strap into the receiver of reel device 10. The method also includes activating reel mechanism, such as by rotating spindle 14 around rotor 16, to rotate the receiver, wherein rotating the receiver causes the second strap to wrap around the receiver.

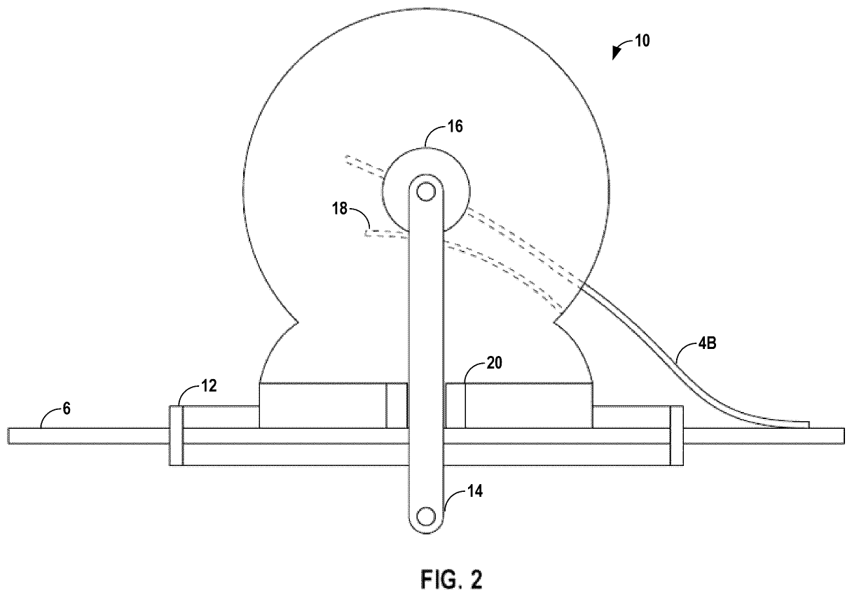

FIG. 2 is a conceptual diagram illustrating a zoomed side view of an example ratchet strap system with reel device 10 described in accordance with the techniques and devices of this disclosure. Reel device 10 is slid onto strap 6, which may be held in place by the pressure provided by strap 6 or a gripping surface on the interior of base 12. Spindle 14, rotor 16, and second end 4B of the second strap are also shown in FIG. 2.

Also shown in FIG. 2 is tongue 18. Tongue 18 may be part of base 12. As shown in FIG. 2, tongue 18 extends upwards towards the receiver to guide the second strap to the receiver.

FIG. 3 is a conceptual diagram illustrating a zoomed side view of an example ratchet strap system with reel device 10 described in accordance with the techniques and devices of this disclosure. As described elsewhere in this disclosure, reel device 10 may include base 12, spindle 14, rotor 16, and tongue 18.

As shown in FIG. 4, reel device 10 may also include receiver 22. A tip of second end 4B of the second strap may be inserted into receiver 22, which is connected to rotor 16. In some instances, receiver 22 may include a gripping mechanism to apply pressure or friction to second end 4B of the second strap in order to keep the tip of the strap in place inside of receiver 22. As receiver 22 rotates, such as by spindle 14 and rotor 16 rotating, second end 4B of the second strap begins wrapping around receiver 22, thereby securing the second strap into place and restricting the second strap from flailing around while the overall system is in motion.

FIG. 4 is a conceptual diagram illustrating a zoomed front view of an example ratchet strap system with reel device 10 described in accordance with the techniques and devices of this disclosure. As described elsewhere in this disclosure, reel device 10 may include base 12, spindle 14, rotor 16, tongue 18, and spindle lock 20.

As shown in FIG. 4, receiver 22 may include a gripping mechanism in an effort to keep the tip of the second strap held in place during the use of reel device 10. In the instance of FIG. 4, the gripping mechanism is a series of teeth that apply pressure at various points across the strap, thereby keeping the strap securely in place while rotor 16 and receiver 22 rotate.

Also shown in FIG. 4 is cover 24. In some instances, to protect the strap from weather and other elements, reel device 10 may include cover 24 to protect the reeled portion of the strap.

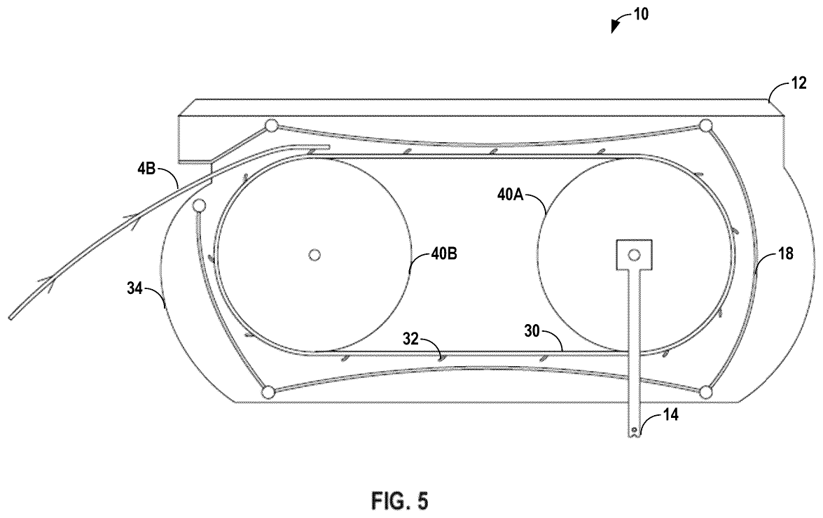

FIG. 5 is a conceptual diagram illustrating an example reel device 10 with a compound receiver 22A and 22B, described in accordance with the techniques and devices of this disclosure. In the example of FIG. 5, reel device 10 may function similarly to reel device 10 of FIGS. 1-4 in that reel device 10 may receive end 4B of a ratchet strap. Reel device 10 may also include base 12, which can either removably slide onto a second strap (e.g., strap 6 of FIG. 1) or may be directly connected to a second strap (e.g., strap 6 of FIG. 1). Reel device 10 may include spindle 14, which may rotate to control the gathering of a ratchet strep with end 4B in or on reel device 10.

In the example of FIG. 5, though, rather than a single receiver on a single rotor, the receiver is made up of a number of components, including axle 40A, axle 40B, and belt 30. Spindle 14, when rotated, may control the rotation of axle 40A such that an angular rotation of spindle 14 is proportional to the angular rotation of axle 40A. The rotation of axle 40A may cause belt 30 to act as a continuous belt around axle 40A and 40B, moving along in the same clockwise or counter-clockwise motion as axle 40A. The forced motion of belt 30 may then cause axle 40B to also rotate.

In some instances, belt 30 may include one or more hooks or barbs 32, or some other form of rough surface that creates large amounts of friction. When end 4B of the ratchet strap is fed into reel device 10, barbs 32 may increase the friction between belt 30 and end 4B of the ratchet strap, or may hook directly into end 4B of the ratchet strap. In this way, the ratchet strap adheres to belt 30 such that, when spindle 14 is rotated and the compound internal receiver is also rotated, the ratchet straps travels reel device 10 along with belt 30 to begin wrapping around belt 30 and axles 40A and 40B.

By changing receiver 22 to being a compound receiver with multiple parts, the overall profile of reel device 10 may decrease, as the surface area of the exposed strap within reel device 10 increases, while also maintaining the same organizational and tidiness benefits of reel device 10 with the singular receiver.

To facilitate the compound receiver made up of axles 40A and 40B and belt 30, tongue 18 may also change form. For instance, as shown in FIG. 5, tongue 18 may go around a majority of the perimeter of belt 30 (e.g., greater than 50%) in order to guide and compress the ratchet strap in multiple points around belt 30. In other instances, tongue 18 may be similar to that of the example of FIG. 2.

In some instances, reel device 10 may be open with belt 30 being exposed. In other instances, reel device 10 may be enclosed, such as by case 34, thereby protecting axles 40A and 40B, belt 30, and the ratchet strap from the elements during use.

In accordance with this disclosure, reel device 10 may include a receiver that is a compound receiver, the compound receiver including a first axle 40A operatively connected to spindle 14. The compound receiver may also include a second axle 40B and a continuous belt 30 that at least partially wraps around each of first axle 40A and second axle 40B. In some instances, continuous belt 30 includes a rough surface, wherein the compound receiver receives end 4B of the strap by adhering end 4B of second strap to the rough surface of the continuous belt. In some such instances, the rough surface of continuous belt 30 includes one or more barbs 32.

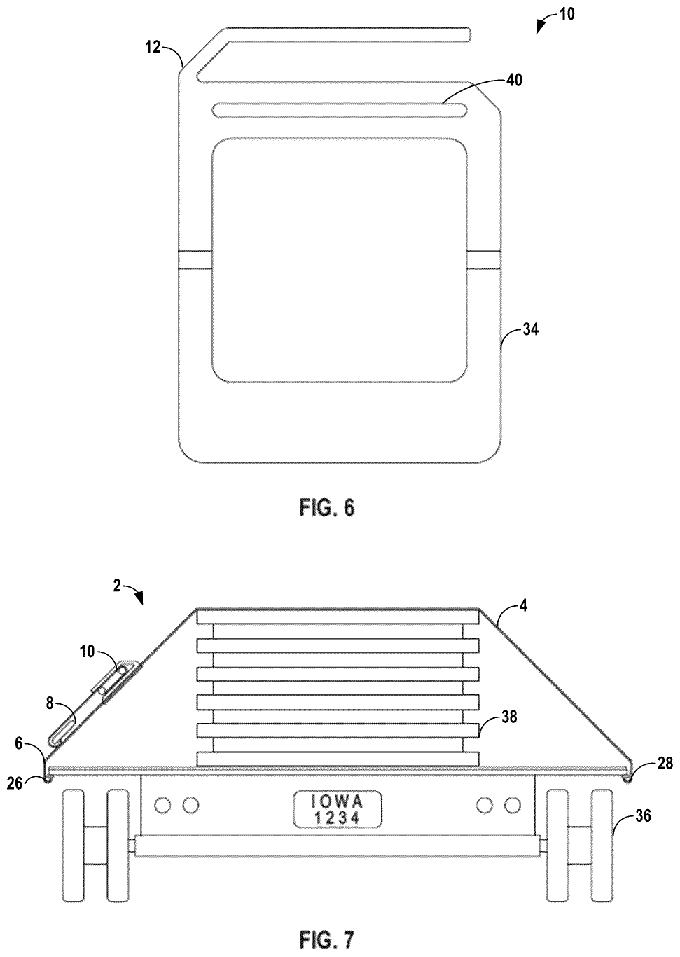

FIG. 6 is a conceptual diagram illustrating a zoomed front view of an example reel device 10, described in accordance with the techniques and devices of this disclosure. In the example of FIG. 10, reel device 10 includes base 12 that slidably receives a ratchet strap. Reel device 10 is enclosed by case 34, with case 34 including opening 40 that receives an end of a ratchet strap, feeding the ratchet strap in to a receiver, such as receiver 22 or a compound receiver as shown in FIG. 5.

FIG. 7 is a conceptual diagram illustrating an example ratchet system 2 with a reel device 10 in use on a truck 36 with a payload 38, described in accordance with the techniques and devices of this disclosure. In the example of FIG. 7, strap 4 is attached to truck 36 via hook 28. Strap 6 is attached to truck 36 via hook 26. Ratchet 8 is attached to strap 6, and receives strap 4. Strap 4 is wrapped around payload 38 to secure payload 38 to struck 36 while truck 36 is in motion. Ratchet 8 ratchets such that strap 4, which is fed into ratchet 8, tightens around payload 38, further securing payload 38 to truck 36, with ratchet 8 configured to ratchet strap 4 until payload 38 is safely secured to truck 36.

Rather than the portion of strap 4 that passes through ratchet 8 be left loose, the portion of strap 4 that passes through ratchet 8 may then be fed into reel device 10. Reel device 10 may receive an end of strap 4, where a user or some other mechanism may activate reel device 10 to secure the loose portion of strap 4. In this way, damage to all of payload 38, truck 36, and other vehicles travelling on a same road as truck 36 may be reduced, as strap 4 would not be flailing around in area surrounding truck 36 and payload 38.

In the example of FIG. 7, reel device 10 is removably and slidably attached to a middle portion of strap 4. In other instances, such as the example shown with respect to FIG. 1, reel device 10 may be placed along strap 6, such as between hook 26 and ratchet 8.

In the example of any of FIGS. 1-7, spindle 14 is mechanical in nature and requires effort input into spindle 14, such as manual effort or effort from some external machine, on order to spin. In other instances, spindle 14 may be automated, or receiver 22/the compound receiver of FIG. 5 may rotate without spindle 14, such as by the use of battery power, solar power, or any other type of fuel, and may only require input from a user via a control panel or remote control in communication with reel device 10.

Various examples of the disclosure have been described. Any combination of the described systems, operations, or functions is contemplated. These and other examples are within the scope of the following claims.

What is claimed is:

1. A ratchet system comprising:
a first strap;
a second strap;
a ratchet mechanism attached to a first end of the first strap; and
a reel device comprising:
a base that removably receives the first strap;
a receiver that removably receives a first end of the second strap; and
a reel mechanism operatively connected to the receiver,
wherein, when the reel mechanism rotates a first angular distance, the receiver rotates a second angular distance proportional to the first angular distance in a same direction as the first angular distance, and
wherein, when the receiver is rotating while receiving the second strap of the ratchet strap system, the second strap wraps around the receiver.

2. The ratchet system of claim 1, wherein the receiver includes a gripping mechanism that secures the first end of the second strap.

3. The ratchet system of claim 2, wherein the gripping mechanism comprises one or more of gripping teeth and a friction pad.

4. The ratchet system of claim 1, wherein the reel device further comprises a stopper mechanism that applies tension to the reel mechanism.

5. The ratchet system of claim 4, wherein the stopper mechanism comprises one or more of a gear and a holder for a spindle of the reel mechanism.

6. The ratchet system of claim 1, wherein the reel mechanism comprises a spindle and a rotor.

7. The ratchet system of claim 1, wherein the base comprises a tongue connected to the base that extends upwards towards the receiver to guide the second strap to the receiver.

8. The ratchet system of claim 1, wherein the base comprises a slot that slides over the first strap to cover at least three sides of the first strap.

9. The ratchet system of claim 1, wherein the receiver further comprises a release mechanism to loosen the hold on the first end of the second strap by the receiver.

10. The ratchet system of claim 1, wherein the first strap includes a hook on a second end of the first strap.

11. The ratchet system of claim 1, wherein the second strap includes a hook on a second end of the second strap.

12. The ratchet system of claim 1, wherein first end of the second strap is first received by ratchet mechanism and then received by the reel mechanism.

13. The ratchet system of claim 1, wherein the receiver comprises a compound receiver, the compound receiver further comprising:
a first axle operatively connected to the reel mechanism;
a second axle; and
a continuous belt that at least partially wraps around each of the first axle and the second axle.

14. The ratchet system of claim 13, wherein the continuous belt comprises a rough surface, wherein the receiver receives the first end of the second strap by adhering the first end of the second strap to the rough surface of the continuous belt.

15. The ratchet system of claim 14, wherein the rough surface of the continuous belt comprises one or more barbs.

16. A reel device for a ratchet strap system, the reel device comprising:
a base that removably receives a first strap of the ratchet strap system;
a receiver that removably receives a second strap of the ratchet strap system; and
a reel mechanism operatively connected to the receiver,
wherein, when the reel mechanism rotates a first angular distance, the receiver rotates a second angular distance proportional to the first angular distance in a same direction as the first angular distance, and
wherein, when the receiver is rotating while receiving the second strap of the ratchet strap system, the second strap wraps around the receiver.

17. The reel device of claim 16, wherein the receiver includes a gripping mechanism that secures the first end of the second strap.

18. The reel device of claim 17, wherein the gripping mechanism comprises one or more of gripping teeth and a friction pad.

19. The reel device of claim 16, wherein the reel device further comprises a stopper mechanism that applies tension to the reel mechanism, wherein the stopper mechanism comprises one or more of a gear and a holder for a spindle of the reel mechanism.

20. The reel device of claim 16, wherein the reel mechanism comprises a spindle and a rotor.

21. The reel device of claim 16, wherein the base comprises a tongue connected to the base that extends upwards towards the receiver to guide the second strap to the receiver.

22. The reel device of claim 16, wherein the base comprises a slot that slides over the first strap to cover at least three sides of the first strap.

23. The reel device of claim 16, wherein the receiver comprises a compound receiver, the compound receiver further comprising:
a first axle operatively connected to the reel mechanism;
a second axle; and
a continuous belt that at least partially wraps around each of the first axle and the second axle.

24. The reel device of claim 23, wherein the continuous belt comprises a rough surface, wherein the receiver receives the first end of the second strap by adhering the first end of the second strap to the rough surface of the continuous belt.

25. The reel device of claim 24, wherein the rough surface of the continuous belt comprises one or more barbs.

26. A method for installing a ratchet strap system, the method comprising:
for a first strap that includes a ratchet mechanism on a first end of the first strap, attaching a first hook on a second end of the first strap to an attachment point on a first surface;
for a second strap that includes a strap tip on a first end of the second strap, attaching a second hook on a second end of the second strap to an attachment point on a second surface;
inserting the strap tip of the second strap into the ratchet mechanism on the first strap;
activating the ratchet mechanism to receive additional portions of the second strap through the ratchet mechanism;
attaching a reel device to the first strap, the reel device comprising a base, a receiver, and a reel mechanism;
inserting the strap tip of the second strap into the receiver of the reel device; and
activating the reel mechanism to rotate the receiver, wherein rotating the receiver causes the second strap to wrap around the receiver.
